(19) United States
(12) Patent Application Publication
(10) Pub. No.: US 2026/0067763 A1
(43) Pub. Date: Mar. 5, 2026

(54) RADIO ACCESS NETWORK CONTROLLED SWITCHING SYSTEMS AND METHODS BETWEEN STANDALONE NETWORKS AND NON-STANDALONE NETWORKS

(71) Applicant: AT&T Intellectual Property I, L.P., Atlanta, GA (US)

(72) Inventors: Wen Yang, Bellevue, WA (US); Ye Chen, Marietta, GA (US); Hongyan Lei, Plano, TX (US); Yupeng Jia, South Pasadena, CA (US)

(73) Assignee: AT&T Intellectual Property I, L.P., Atlanta, GA (US)

(21) Appl. No.: 18/825,509

(22) Filed: Sep. 5, 2024

(51) Int. Cl. H04W 36/00; H04W 36/38

(52) U.S. Cl. CPC H04W 36/00698; H04W 36/38

(57) ABSTRACT

Aspects of the subject disclosure may include, for example, inquiring capability of a target user equipment (UE) connected to a standalone radio access network (SA RAN) operating with a n^{th} generation communication network, determining the inquired capability that the target UE supports a first type of dual connectivity and does not support a second type of dual connectivity, receiving, from the target UE, a message that a predetermined condition has occurred, and moving the connection to the target UE to a radio access network (RAN) of a (n−1)^{th} generation communication network. Other embodiments are disclosed.

### FIELD OF THE DISCLOSURE

The subject disclosure relates to radio access network (RAN) controlled switching systems and methods between standalone (SA) networks and non-standalone (NSA) networks.

### BACKGROUND

Certain models of 5G devices, such as legacy 5G devices, budget models, or cost focused models, may not yet fully support certain features of 5G radio access network (RAN) capacity. For instance, legacy 5G devices may not support 5G features such as uplink carrier aggregation (UL CA), downlink carrier aggregation (DL CA) including 3 inter band CA (DL 3CA), 4 inter band CA (DL 4CA), 5 inter band CA (DL 5CA), new radio dual connectivity (NRDC) for mmWave coverage, etc. In certain situations, 4G LTE radio may provide better user experience for mmWave coverage, for instance, with respect to 5G devices supporting E-UTRAN New Radio-Dual Connectivity (ENDC). According to 3GPP standards, the ENDC technique allows 5G user devices to connect to a 5G gNodeB as an anchor node and connect to an LTE eNodeB as a secondary node. However, 5G user devices not equipped with the ENDC may not be connected to the 4G LTE radio.

FIG. 1 illustrates an exemplary operation of different user equipment (UE) The different UE include UEs of Type 1, Type 2 and Type 3 by way of example only. UEs of Type 1 correspond to 4G LTE UEs operating under the LTE standard and connected with an eNodeB of the 4G LTE as a main cell group (MCG). UEs of Type 2 correspond to 5G UEs which are operating under the 5G standard and connected to a gNode B of 5G radio access networks (RAN) as a main cell group (MCG) (i.e., as an anchor node). UEs of Type 3 correspond to 5G UEs with limitation(s), e.g., legacy 5G UEs, budget models, etc., which may not fully support all of the features of 5G RAN, such as NRDC, ENDC, etc. Most network service providers use ENDC to optimize both 5G and 4G LTE networks. UEs of Type 2 is equipped with ENDC and can be connected to an eNodeB of NSA LTE RAN as a secondary cell group (SCG) (i.e., the gNodeB being still an anchor node) in certain situations such as connected to a mmWave node. However, UEs of Type 3, lacking the NRDC and the ENDC features, stay on the 5G RAN without utilizing 5G mmWave coverage. As a result, as depicted in FIG. 1, throughput potentials of UEs of Type 3 may be not as fair as those of UEs of Type1 and UEs of Type 2.

### BRIEF DESCRIPTION OF THE DRAWINGS

Reference will now be made to the accompanying drawings, which are not necessarily drawn to scale, and wherein:

FIG. 1 illustrates conventional operations of different user equipment.

FIG. 2A is a block diagram illustrating an exemplary, non-limiting embodiment of a communications network in accordance with various aspects described herein.

FIG. 2B is a block diagram illustrating an example, non-limiting embodiment of a system functioning within the communication network of FIG. 1 in accordance with various aspects described herein.

FIG. 2C depicts an illustrative embodiment of a 5G standalone platform and a 5G non-standalone platform.

FIG. 2D depicts an illustrative embodiment of a Downlink Dual Connectivity Channel (DL-DCCH) message in accordance with various aspects described herein.

FIG. 2E depicts an illustrative embodiment of user equipment assistance information in accordance with various aspects described herein.

FIG. 2F depicts an illustrative embodiment of a method in accordance with various aspects described herein.

FIG. 2G depicts an illustrative embodiment of another method in accordance with various aspects described herein.

FIG. 2H depicts an illustrative embodiment of yet another method in accordance with various aspects described herein.

FIG. 2I depicts an illustrative embodiment of further yet another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for radio access network (RAN) controlled switching systems and methods between standalone (SA) networks and non-standalone (NSA) networks. The systems and methods facilitate switching a user equipment camped on the SA networks to the NSA networks upon detection of a predetermined condition. For instance, the predetermined condition corresponds to mmWave coverage and the UE can switch to the NSA networks which may provide dual coverage including a low frequency band and a mmWave band. The UE supports E-UTRAN New Radio-Dual Connectivity to the SA networks and the NSA networks. Other embodiments are described in the subject disclosure.

One or more aspects of the subject disclosure are directed to a device including a processing system having a processor and a memory that stores executable instructions that, when executed by the processing system, facilitate performance of operations. The operations include inquiring capability of a target user equipment (UE) connected to a standalone radio access network (SA RAN) operating with a n^{th} generation communication network, determining the inquired capability of the target UE that the target UE supports a first type of dual connectivity and does not support a second type of dual connectivity, receiving, from the target UE, a message that a predetermined condition has occurred, and moving the connection to the target UE to a radio access network (RAN) of a (n−1)^{th} generation communication network.

One or more aspects of the subject disclosure are directed to a non-transitory machine-readable medium, comprising executable instructions that, when executed by a processing system including a processor, facilitate performance of operations. The operations include connecting to a network counterpart in a standalone radio access network (SA RAN) operating with a n^{th} generation communication network, receiving, from the network counterpart, an inquiry about capability of the user equipment (UE), informing the network counterpart of the inquired capability of the UE that an E-UTRAN New Radio Dual Connectivity (ENDC) feature is activated and a New Radio Dual Connectivity (NRDC) feature is not supported, reporting, to the network counterpart, a detection of a predetermined condition, and based on a handover command from the network counterpart, switching to a radio access network (RAN) of a (n−1)^{th} generation communication network.

One or more aspects of the subject disclosure are directed to a method including inquiring, by a processing system including a processor, capability of a first user equipment (UE) connected to a standalone radio access network (SA RAN) operating with a n^{th} generation communication network; determining, by the processing system, the inquired capability of the first UE that the first UE supports an E-UTRAN New Radio Dual Connectivity (ENDC) function and does not support New Radio Dual Connectivity (NRDC) function; receiving, by the processing system, from the first UE, a first message that a predetermined condition has been detected; and handing over, by the processing system, the connection to the first UE to a radio access network (RAN) of a (n−1)^{th} generation communication network.

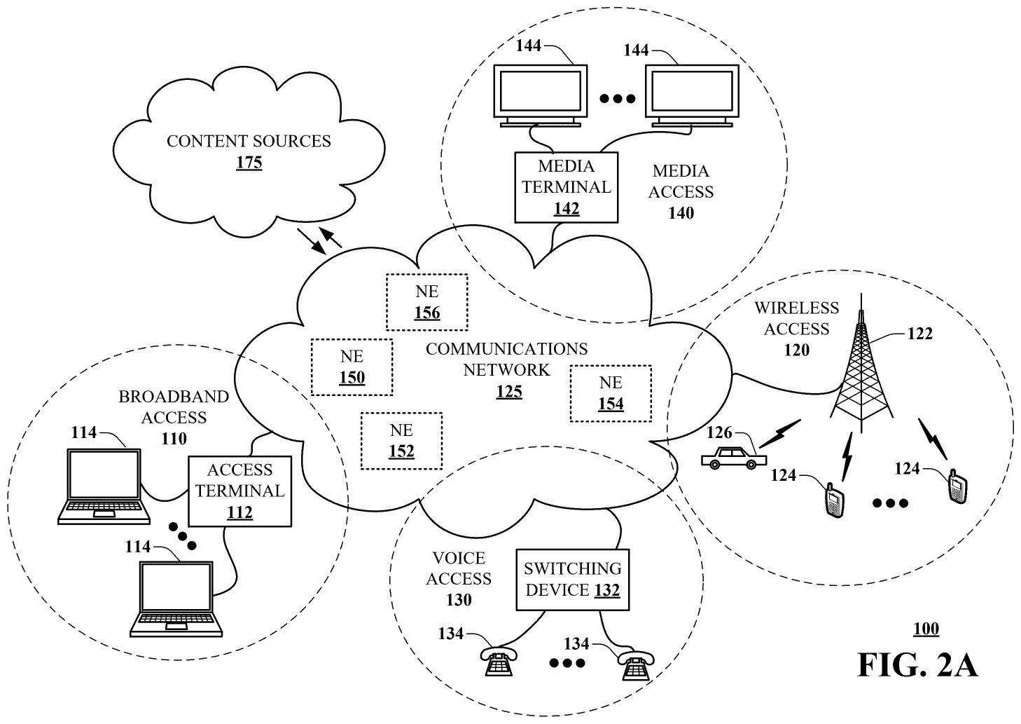

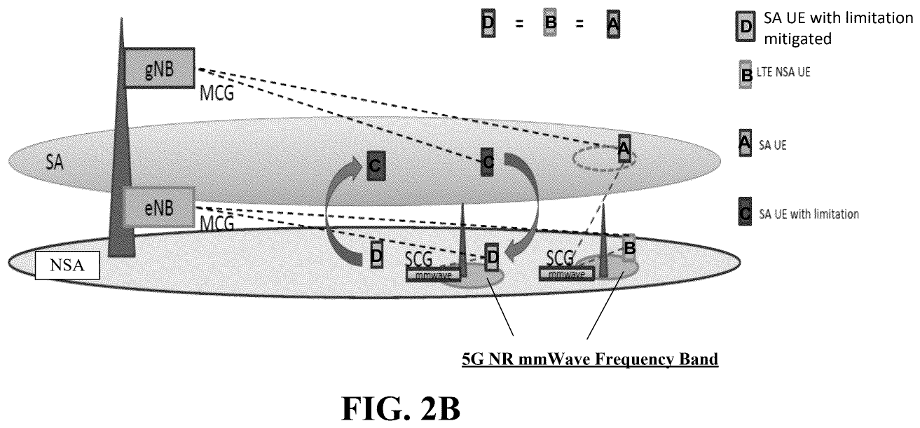

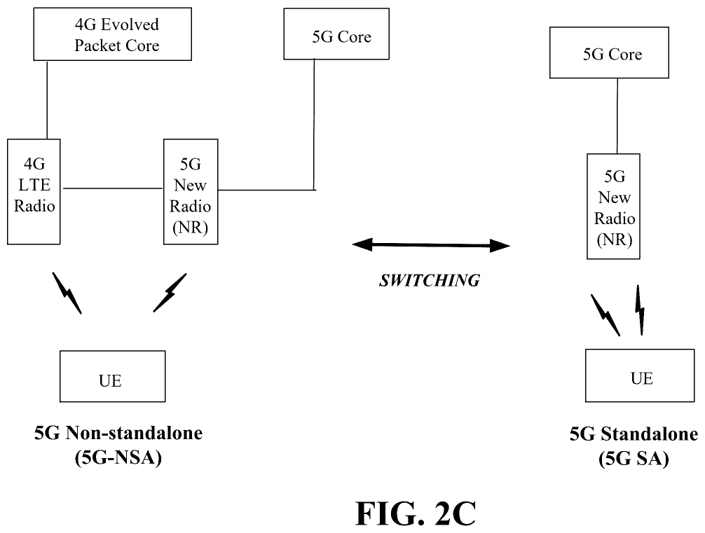

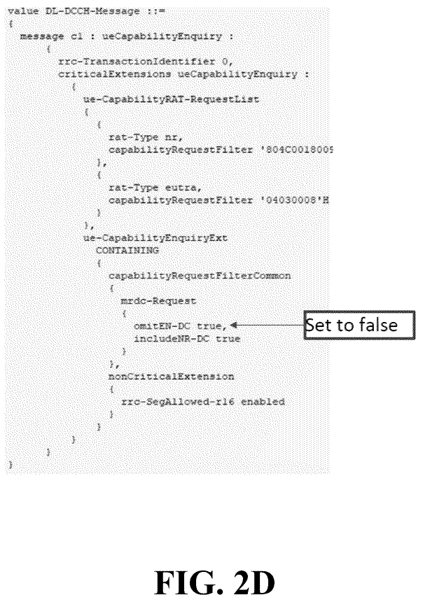

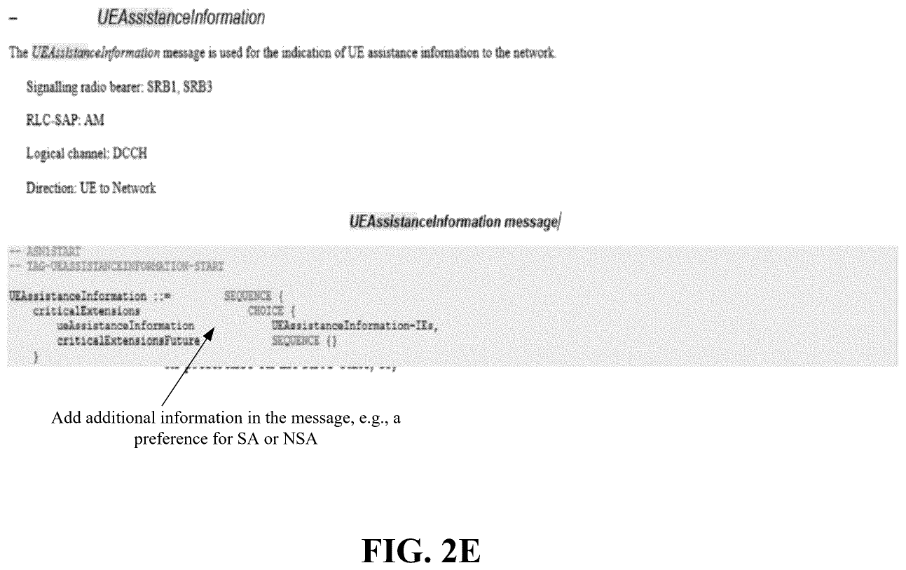

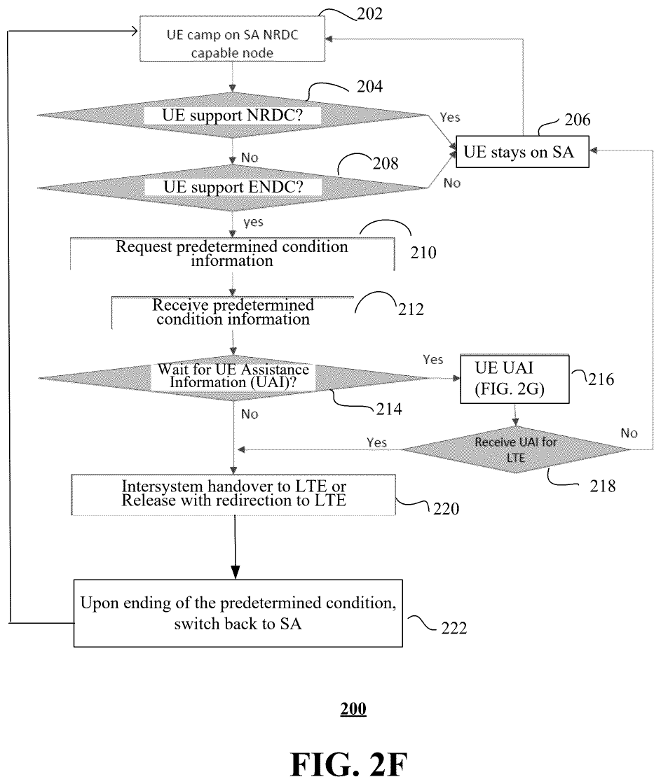

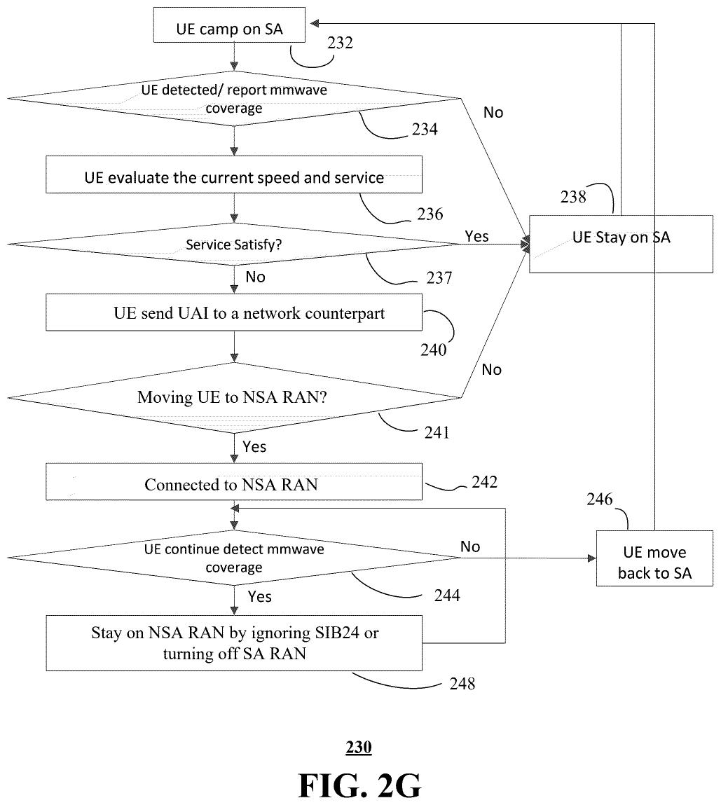

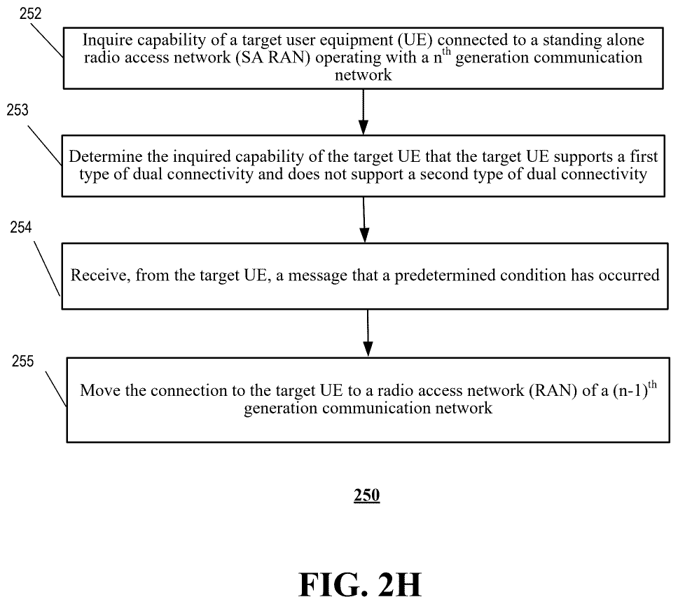

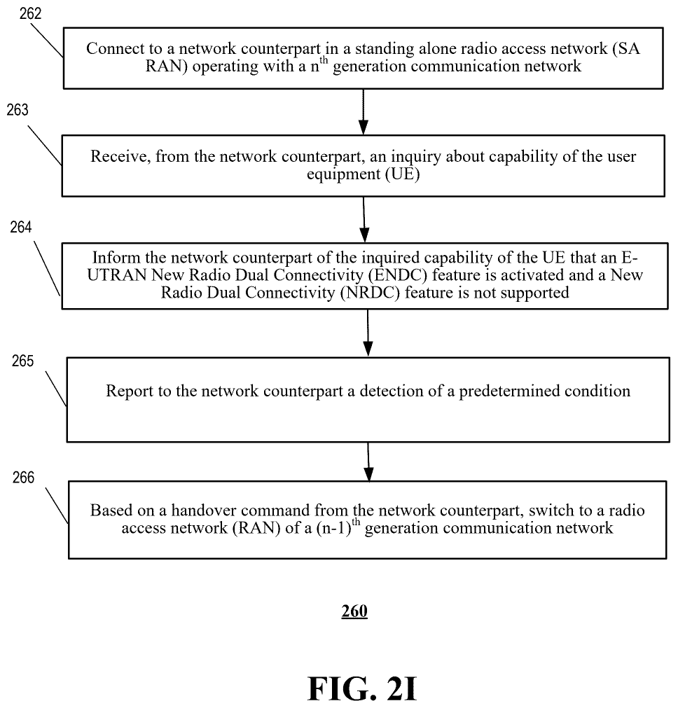

Referring now to FIG. 2A, a block diagram is shown illustrating an example, non-limiting embodiment of a system 100 in accordance with various aspects described herein. For example, system 100 can facilitate in whole or in part systems and methods for mixing and matching multi-operator baseband unit and radio unit in open radio access (ORAN) networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

FIG. 2B is a block diagram illustrating an example, non-limiting embodiment of a system functioning within the communication network of FIG. 2A in accordance with various aspects described herein. In various embodiments, different UEs include UEs of Type A, Type B, Type C, and Type D by way of example only. UEs of Type A correspond to standalone (SA) UEs operating with a n^{th} generation communication standard, such as the 5G standard. UEs of Type B correspond to non-standalone (NSA) UEs operating under a (n−1)th generation standard, such as the 4G LTE standard. UEs of Type C correspond to SA UEs with limitation(s), e.g., legacy SA UEs, budget model SA UEs, etc. UEs of Type D correspond to UEs of Type C with limitation(s) which have been mitigated based on dynamic RAN switching.

FIG. 2C depicts an illustrative embodiment of a 5G standalone (SA) platform and a 5G non-standalone (NSA) platform in accordance with various aspects described herein. The present disclosure is described using the 5G standard and the 4G LTE standard for convenience of description but the present disclosure is not limited thereto and can cover a higher generation standard such as 6G or upcoming generation standards which utilize NSA and SA architecture (e.g., 6G SA and 5G NSA, etc.). The 5G SA platform includes 5G new radio (NR) and 5G mobile core and user equipment (UE) is connected to the 5G mobile core via the 5G NR. The 5G NSA platform includes 5G NR connected to the 5G mobile core and in addition, 4G LTE radio connected to 4G Evolved Packet Core and the 5G mobile core.

E-UTRAN New Radio-Dual Connectivity (ENDC) is an NSA aspect of the 5G deployments that allow UE to access both 5G and 4G LTE networks at the same time. ENDC allows 4G LTE and 5G bandwidth to be used at the same time, and when user devices attempt to download content, such as a video, the speed at which that video transfers comes from both 4G LTE and 5G simultaneously. If a user device were to move to an area where 5G is unavailable, they would seamlessly continue using 4G LTE. ENDC also provides added bandwidth that comes from combining the 5G and the 4G LTE, which may lead to improved reliability and faster speed. A few limitations of ENDC are that a user device may need to have two modems to connect to 4G LTE and 5 and that power consumption will be relatively higher for using ENDC.

In the 5G networks, spectrum of 6 GHz can be seen as a dividing line for mmWave, which is that spectrum above 6 GHz corresponds to mmWave and spectrum below 6 GHz is not mmWave. In lower frequency spectrum such as sub-6 GHz, radio waves can propagate farther than mmWave and penetrate solid objects better than mmWave spectrum. Sub-6 GHz may provide a broader coverage than mmWave spectrum, although mmWave spectrum may provide ultra-fast data speed. Given the coverage and performance associated with different spectrums, network service providers need to consider a tradeoff between faster speeds (mmWave) and broader coverage areas (sub-6 GHz). ENDC allows the UE to tap into a 4G LTE low frequency band (sub-6 GHz) and 5G mmWave coverage.

Referring back to FIG. 2B, in various embodiments, SA UEs (Type A) and SA UEs with limitation(s) (Type C) are connected with a gNodeB as a main cell group (MCG) in the 5G SA RAN. When SA UEs (Type A) support New Radio Dual Connectivity (NRDC), SA UEs (Type A) can connect to both a sub-6 GHz node (gNB) as a MCG and mmWave node (gNB) as a SCG, as depicted in FIG. 2B. NSA UEs (Type B) are connected to an eNodeB as a MCG in the 4G LTE NSA RAN. NSA UEs (Type B) can also be connected to a mmWave node (gNB) as a secondary node.

In mmWave coverage situations described above, SA UEs with limitation(s) (Type C) may not support NRDC and have no dual connectivity to both sub-6 GHz and mmWave coverage. As depicted in FIG. 2B, SA UEs with limitation(s) (Type C) can be connected to or handed over to the NSA RAN as a MCG (i.e., as an anchor node). At the same time, SA UEs with limitation(s) (Type C) can be connected to a mmWave node as a secondary node. In the 5G NSA network, defining an anchor point is an essential step to ensure smooth handovers between the 5G and 4G networks. The anchor point is the node in the network that manages the handover process between the 5G and the 4G networks. Thus, as shown in FIG. 2B, SA UEs with limitation(s) (Type C), can switch to the NSA RAN, which have described as SA UEs (Type D) as the limitations can be mitigated. Once the mmWave coverage is no longer detected, SA UEs with limitation(s) (Type C) will switch back to the SA RAN.

In various embodiments, in order to move and keep the SA UEs with limitations (Type C) on the NSA LTE RAN as a MCG, it is necessary to determine whether SA UEs with limitations (Type C) will move or not. Such determination can be made on UE's end only, UE/SA RAN jointly or by the SA RAN only. The determination is made based on the following sequences. When a target UE is camped on the SA RAN, the SA RAN detects whether the target UE supports the ENDC and does not support NRDC based on UE capability exchange. FIG. 2D depicts one example of definition of DL_DCCH. As depicted in FIG. 2D, a UE capability inquiry message is sent and an information element, “omitEN-DC true” in a downlink dual connectivity channel (DL-DCCH message) is set to false. The SA RAN configures the target UE to report mmWave measurements. Currently, the SA RAN may be configured to receive mmWave measurements from UEs supporting NRDC. There are multiple ways to trigger UEs to scan mmWave, such as periodically or event-based (e.g., data aware), or based on a gNodeB configuration. For instance, the gNodeB configuration corresponds to a SA node that has NRDC relation to mmWave cells. The event-based scan involves applications running on the target UE to require particular requirements such as low latency, large bandwidth, etc.

In various embodiments, the target UE reports the mmWave coverage, and the SA RAN evaluates whether to move the target UE to the NSA RAN or wait for UE indication. The UE indication includes receiving from a UE an indication to stay on the SA RAN or moving or switching to the NSA RAN using a UE Assistance Information (UAI) process. In certain embodiments, the SA RAN may not wait for the UE indication and determine to move the target UE to the NSA RAN or not. In other words, the SA RAN may treat the UE indication as optional information and makes a determination to move the target UE or not.

In various embodiments, the SA RAN uses a release with redirection, or intersystem handover or inter-RAT handover to move the target UE to the NSA LTE RAN. The release with redirection (RwR) is a network-controlled mobility feature that allows LTE capable user equipment to move from a wideband code division multiple access (WCDMA) access network to an LTE access network. RwR helps UEs transition back to LTE more quickly by detecting if a UE has been inactive for a predetermined amount of time and determining if it will have enough signal quality to operate in the LTE network. Redirection is a process in which an gNodeB sends an RRC connection release message to a UE and instructs the UE to access a target frequency or frequency group. The RRC connection release message includes redirection information. The gNodeB sends system information of a target cell for redirection to the UE through the RRC connection release message which may reduce the delay in accessing the target cell. Intersystem handover or inter-RAT handover occurs when the UE transitions from one radio access technology to another such as 5G to 4G, etc.

In various embodiments, the SA RAN is configured to determine a predetermined condition that triggers switching to the NSA RAN. For instance, the predetermined condition includes coverage, UE capability, data present in a buffer, etc. As one example, the SA RAN initiates the release with redirection, or the intersystem handover or inter-RAT handover to move the target UE to the NSA LTE RAN where mmWave coverage is detected. UEs including the target UE may ignore or disable System Information Block 24 (SIB24) or disables the SA networks while UEs are under the mmWave coverage and re-enable the SA networks after moving out of the mmWave coverage. On mixed networks with both 5G SA and 4G LTE (i.e., the NSA networks), SIB24 is configured at the LTE side to broadcast all the cell reselection information for the 5G UE, so it can perform cell reselection from 4G towards 5G. This broadcast message helps ensure that UEs receive necessary network information to scan for the 5G SA network. If SIB24 is disabled, the cell reselection is not working towards 5G.

In various embodiments, as another example, the SA RAN initiates the release with redirection, or the intersystem handover or inter-RAT handover to move the target UE to the NSA LTE RAN when data are in a buffer, which indicates requiring larger bandwidth. Then the NSA LTE RAN configures the ENDC function. UEs including the target UE may ignore or disable System Information Block 24 (SIB24) or disables the SA networks until the data in the buffer condition is ended and re-enable the SA networks. As further another example, the SA RAN initiates the release with redirection, or the intersystem handover or inter-RAT handover to move the target UE to the NSA LTE RAN based on information from UEs such as a preference between the SA RAN and the NSA RAN, as will be described below. This UE information is optionally considered by the SA RAN.

FIG. 2E depicts a non-limiting example of UE assistance information. As described above, the SA RAN may wait for UE assistance information (UAI) to make a determination to move the target UE to the NSA RAN. The UE assistance information procedure is sending a message from an UE to a network to provide UE assistance information. Under the 3GPP TS 38.331 V17.4.0 (2023-03), the UAI is defined as shown in FIG. 2E However, the UAI defined under the current 3GPP standard does not include any information relating to switching or selection between the SA RAN and the NSA RAN. In accordance with various embodiments of the present disclosure, additional information can be added to indicate a preference for the SA RAN or the NSA RAN by the target UE. The SA RAN is not mandated to wait for the UAI and cam make a determination based on the UAI or alternatively, ignore the UAI including the preference indicated by the target UE. In other words, the UAI may not mandate the SA RAN to proceed with the SA or NSA preference included in the UAI.

FIG. 2F depicts an illustrative embodiment of a method 200 in accordance with various aspects described herein. In various embodiments, the method 200 is directed to a RAN controlled switching between a standalone (SA) RAN and a non-standalone (NSA) RAN. For instance, the SA RAN operates under the 5G networks and the NSA RAN operates under the 4G LTE networks. UEs camp on a SA New Radio Dual Connectivity (NRDC) capable node (Step 202), which allows a UE to be connected to sub-6 GHz spectrum in mmWave coverage. For the mmWave coverage, mmWave propagation fades in urban environments due to building penetration loss, Non-Line-Of-Sight(NLOS) conditions, etc. Switching to low frequency spectrum (i.e., sub-6 GHz) may address the mmWave coverage issues as low frequency spectrum facilitates a broader coverage than the mmWave coverage.

In various embodiments, the method 200 includes determining whether a target UE supports New Radio Dual Connectivity (NRDC) in the mmWave coverage situation (Step 204). Upon determination that the target UE supports NRDC, then the method 200 includes requesting the target UE to stay on the SA (Step 206). The target UE can tap into sub-6 GHz spectrum when mmWave coverage is detected. Upon determination that the target UE does not support NRDC, then the method 200 includes determining whether the target UE supports ENDC (Step 208). For instance, the SA RAN may detect whether the target UE supports the ENDC and does not support NRDC based on UE capability exchange, as depicted in FIG. 2D as the example of DL_DCCH. Upon detection, in the UE capability inquiry message, an information element, “omitEN-DC true” in the downlink dual connectivity channel (DL-DCCH message) is set to false. Upon finding support for the ENDC by the target UE, the method 200 includes requesting the target UE to send information relating to a predetermined condition (Step 210). The SA RAN configures the target UE to report mmWave measurements. Currently, the SA RAN may be configured to receive mmWave measurements from UEs supporting NRDC. There are multiple ways to trigger UEs to scan mmWave, such as periodically or event-based (e.g., data aware), or based on a gNodeB configuration. For instance, the gNodeB configuration corresponds to a SA node that has NRDC relation to mmWave cells. The event-based scan involves applications running on the target UE to require particular requirements such as low latency, large bandwidth, etc.

In various embodiments, the method 200 further includes receiving, from the target UE, the predetermined condition information, such as measurements for mmWave to the SA RAN (Step 212). Additionally, or alternatively, the method 200 further includes checking and detecting data in a buffer which requires larger bandwidth UE (Step 212). The method 200 includes determining to wait for UE assistance information (UAI) of the target UE (Step 214) and upon determination of no UAI, then performing packet switched handover (PSHO) to the NSA LTE or Release with redirection to LTE (Step 220). Additionally, or alternatively, the method 200 further includes waiting for UE assistance information (UAI) (Step 214) and receiving the UAI for LTE (Step 216). In some embodiments, the method 200 further includes receiving UAI which prefers the NSA LTE RAN (Step 218). The method 200 includes, upon ending of the predetermined condition, switching the target UE back to the SA RAN (Step 222). For instance, when the predetermined condition corresponds to coverage, the SA RAN controls the target UE to switch to the NSA LTE RAN while the target UE is in mmWave coverage and when the target UE is out of mmWave coverage, to stay on the SA RAN. As another example, when the predetermined condition corresponds to data in the buffer, the SA RAN controls the target UE to move back to the SA RAN by detecting that the buffer is cleared.

FIG. 2G depicts an illustrative embodiment of another method 230 in accordance with various aspects described herein. In various embodiments, the method 230 is directed to switching between a SARAN and a NSA RAN where UAI is triggered. Upon determination that the UAI is triggered, a target UE stays on the SA RAN if current network performance such as speed and service, etc., can satisfy the service requested by the target UE. If the current network performance may not satisfy the service requested by the target UE, a request is made to the SA RAN for switching and moving to the NSA RAN and stay on the NSA RAN by ignoring SIB24 or temporarily disabling the SA network.

In various embodiments, the method 230 includes the target UE camping on the SA RAN (Step 232). The target UE detects and reports certain conditions that trigger switching between the SA RAN and the NSA LTE RAN (Step 234). For instance, the certain conditions that trigger the switching between the SA RAN and the NSA LTE RAN include mmWave coverage. Upon detection of the mmWave coverage, for example, the target UE evaluates a current speed and services offered by the SA RAN (Step 236). If the target UE finds the current speed and services satisfactory (Step 237), then the target UE stays on the SA RAN (Step 238). If the current speed and services are found unsatisfactory, then the target UE sends User Equipment Assistance Information (UAI) to a network counterpart (Step 240). The network counterpart determines whether to move the target UE to the NSA RAN or not (Step 241). Upon determination of moving the target UE to the NSA RAN (Step 241), the target UE gets on the NSA RAN (Step 242). Otherwise the target UE stays on the SA RAN (Step 238).

In various embodiments, the method 230 further includes determining whether the target UE continues to detect mmWave coverage or not (Step 244). If the target UE no longer detects the mmWave coverage, then the target UE will move back to the SA RAN (Step 246). If the target UE continues to detect the mmWave coverage, the target UE stays on the NSA LTE RAN by ignoring SIB24 or temporarily turning off the SA connection (Step 248).

As depicted in FIG. 2G, the method 230 describes the mmWave coverage situation but the method 230 is not limited thereto. The UE SA/NSA switching decision could be based on various other factors such as battery life, speed, end user preferences (e.g. via device settings configured by users), application performance requirements known by devices, etc. The UE SA/NSA switching decision can be made by the UE only, the UE/the network counterpart, or the network counterpart only.

FIG. 2H depicts an illustrative embodiment of yet another method 250 in accordance with various aspects described herein. In various embodiments, the method 250 includes inquiring capability of a target user equipment (UE) connected to a standalone radio access network (SA RAN) operating with a n^{th} generation communication network (Step 252), determining the inquired capability of the target UE that the target UE supports a first type of dual connectivity and does not support a second type of dual connectivity (Step 253), receiving, from the target UE, a message that a predetermined condition has occurred (Step 254), and moving the connection to the target UE to a radio access network (RAN) of a (n−1)^{th} generation communication network (Step 255).

In various embodiments, the target UE is connected to the SA RAN operating with a 5G communication network and the moving the connection to the target UE further comprises moving the connection to the target UE to the RAN of a 4G LTE communication network. The determining that the target UE supports the first type of dual connectivity further comprise determining that the target UE supports E-UTRAN New Radio Dual Connectivity (ENDC). The determining that the target UE does not support the second type of dual connectivity further comprise determining that the target UE does not support New Radio Dual Connectivity (NRDC).

In various embodiments, the moving the connection to the target UE further comprise releasing the connection to the target UE with a redirection to the RAN of the (n−1)^{th} generation communication network. Alternatively, the moving the connection to the target UE further comprise performing intersystem handover or inter-radio access technology handover from the RAN of the n^{th} generation communication network to the RAN of the (n−1)^{th} generation communication network. The method 250 includes receiving UE assistance information (UAI) from the target UE and analyzing the received UAI to determine a preference of the target UE to stay on the SA RAN of the n^{th} generation communication network or move to the RAN of the (n−1)^{th} generation communication network.

In various embodiments, the receiving the message that the predetermined condition has occurred further comprises receiving the message that the target UE has detected mmWave coverage. The moving the connection to the target UE further comprises moving the connection to the target UE to the RAN of a 4G LTE communication network as a main cell group. The method further comprise connecting the target UE to a mmWave node of the SA RAN as a secondary cell group.

In various embodiments, the method 250 further comprise detecting data in a buffer. The moving the connection to the target UE further comprises moving the connection to the target UE to the RAN of a 4G LTE communication network as a main cell group. The method further comprise connecting the target UE to a node of the SA RAN as a secondary cell group.

FIG. 2I depicts an illustrative embodiment of yet another method 260 in accordance with various aspects described herein. In various embodiments, the method 260 includes connecting to a network counterpart in a standalone radio access network (SA RAN) operating with a n^{th} generation communication network (Step 262), receiving, from the network counterpart, an inquiry about capability of the user equipment (UE)(Step 263), informing the network counterpart of the inquired capability of the UE that an E-UTRAN New Radio Dual Connectivity (ENDC) feature is activated and a New Radio Dual Connectivity (NRDC) feature is not supported (Step 264), reporting to the network counterpart a detection of a predetermined condition (Step 265), and based on a handover command from the network counterpart, switching to a radio access network (RAN) of a (n−1)^{th} generation communication network (Step 266).

In various embodiments, the method further 260 comprise, while the predetermined condition is ongoing, disregarding system information block 24 or turning off a SA RAN mode, thereby staying on the RAN of a (n−1)^{th} generation communication network, determining that the predetermined condition is no longer detected, and moving back to the SA RAN operating with the n^{th} generation communication network. The connecting to the SA RAN further comprise connecting to the SA RAN operating with a 5G communication network. The switching to the RAN further comprises switching to the RAN of a 4G LTE communication network. The method further comprise sending, to the network counterpart, the UE assistance information including a preference for the SA RAN operating with the 5G communication network or the RAN of the 4G LTE communication network.

In various embodiments, the method 260 further comprises determining the preference for the SA RAN operating with the 5G communication network or the RAN of the 4G LTE communication network based on a battery life, a network traffic speed, an end user preference configured in the UE, application performance requirements, or a combination thereof. The reporting to the network counterpart the detection of a predetermined condition further comprises reporting to the network counterpart the detection of mmWave coverage. The method 260 further comprise connecting to an anchor node of the (n−1)^{th} generation communication network as a main cell group and connecting to a mmWave node of the n^{th} generation communication network as a secondary cell group.

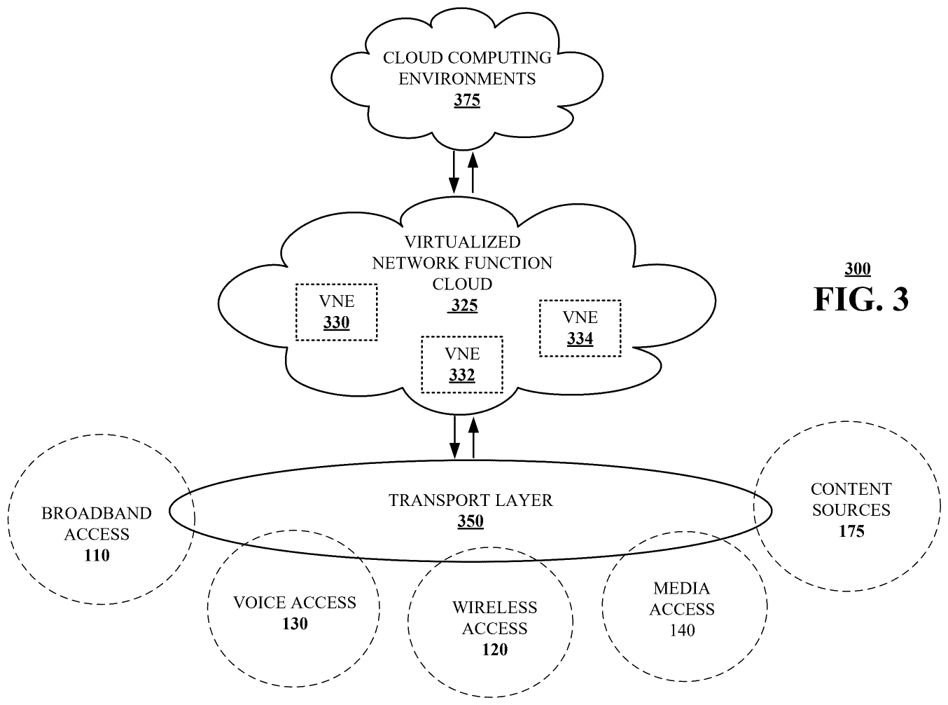

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of systems and methods 200, 230, 250 and 260 presented in FIGS. 2B, 2F through 2I, and 3. For example, virtualized communication network 300 can radio access network (RAN) controlled switching systems and methods between standalone (SA) networks and non-standalone (NSA) networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

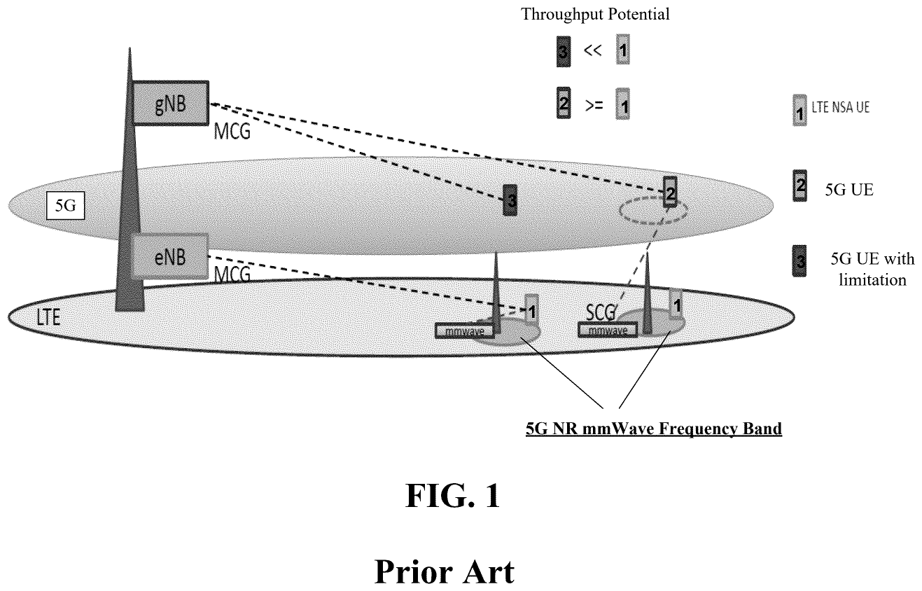

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

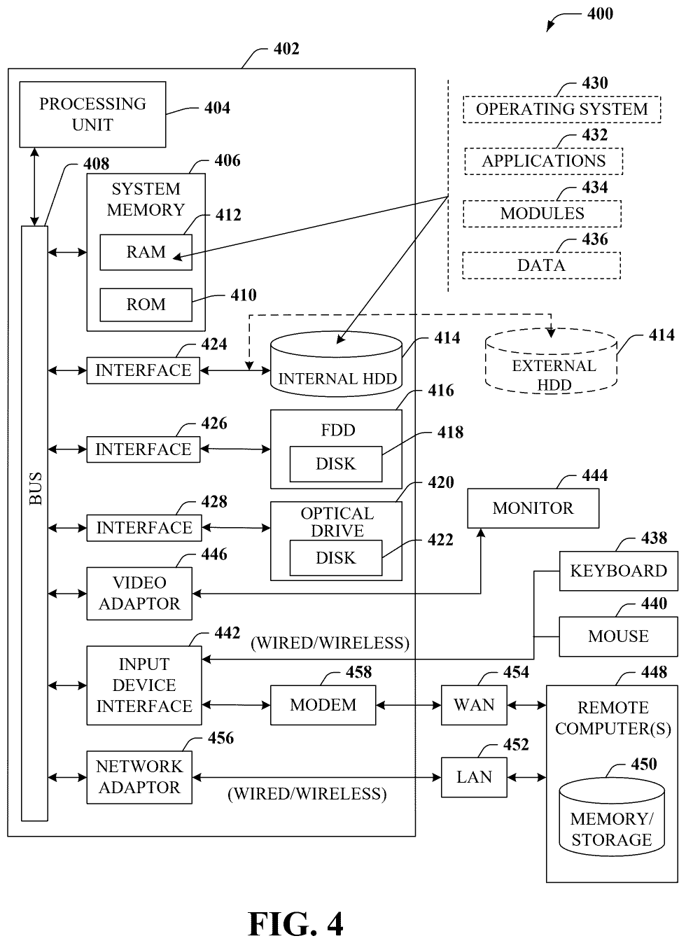

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part radio access network (RAN) controlled switching systems and methods between Standalone (SA) networks and non-standalone (NSA) networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

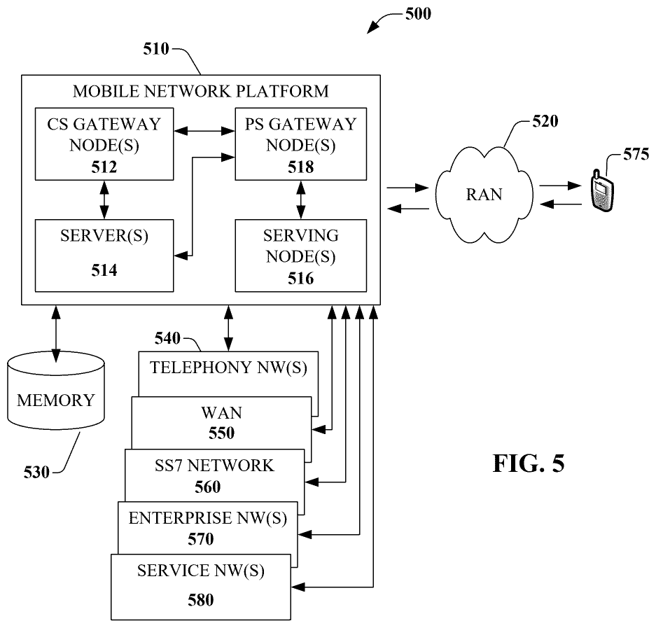

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part radio access network (RAN) controlled switching systems and methods between standalone (SA) networks and non-standalone (NSA) networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

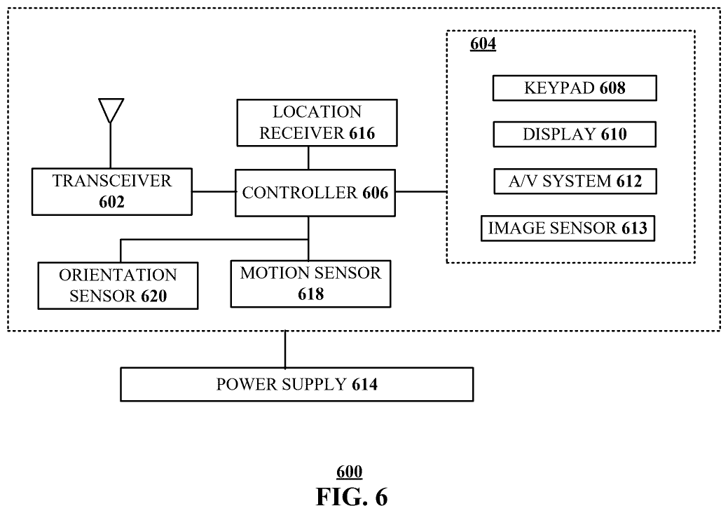

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part radio access network (RAN) controlled switching systems and methods between standalone (SA) networks and non-standalone (NSA) networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
inquiring capability of a target user equipment (UE) connected to a standalone radio access network (SA RAN) operating with a n^{th} generation communication network;
determining the inquired capability of the target UE that the target UE supports a first type of dual connectivity and does not support a second type of dual connectivity;
receiving, from the target UE, a message that a predetermined condition has occurred; and
moving the connection to the target UE to a radio access network (RAN) of a (n−1)^{th} generation communication network.

2. The device of claim 1, wherein the target UE is connected to the SA RAN operating with a 5G communication network and the moving the connection to the target UE further comprises moving the connection to the target UE to the RAN of a 4G LTE communication network.

3. The device of claim 1, wherein the determining that the target UE supports the first type of dual connectivity further comprise determining that the target UE supports E-UTRAN New Radio Dual Connectivity (ENDC).

4. The device of claim 3, wherein the operations further comprise:
determining that the target UE does not support the second type of dual connectivity further comprise determining that the target UE does not support New Radio Dual Connectivity (NRDC).

5. The device of claim 1, wherein the moving the connection to the target UE further comprise releasing the connection to the target UE with a redirection to the RAN of the (n−1)^{th} generation communication network.

6. The device of claim 1, wherein the moving the connection to the target UE further comprise performing intersystem handover or inter-radio access technology handover from the RAN of the n^{th} generation communication network to the RAN of the (n−1)^{th} generation communication network.

7. The device of claim 1, wherein the operations comprise:
receiving UE assistance information (UAI) from the target UE; and
analyzing the received UAI to determine a preference of the target UE to stay on the SA RAN of the n^{th} generation communication network or move to the RAN of the (n−1)^{th} generation communication network.

8. The device of claim 2, wherein:
the receiving the message that the predetermined condition has occurred further comprises receiving the message that the target UE has detected mmWave coverage; and
the moving the connection to the target UE further comprises moving the connection to the target UE to the RAN of a 4G LTE communication network as a main cell group; and
the operations further comprise connecting the target UE to a mmWave node of the SA RAN as a secondary cell group.

9. The device of claim 2, wherein the operations comprise detecting data in a buffer; and
wherein the receiving the message that the predetermined condition has occurred further comprises receiving the message that the target UE is within mmWave coverage; and the moving the connection to the target UE further comprises moving the connection to the target UE to the RAN of a 4G LTE communication network as a main cell group; and
the operations further comprise connecting the target UE to a node of the SA RAN as a secondary cell group via the first type of dual connectivity.

10. A non-transitory machine-readable medium, comprising executable instructions that, when executed by a processing system of a user equipment including a processor, facilitate performance of operations, the operations comprising:
connecting to a network counterpart in a standalone radio access network (SA RAN) operating with a n^{th} generation communication network;
receiving, from the network counterpart, an inquiry about capability of the user equipment (UE);
informing the network counterpart of the inquired capability that an E-UTRAN New Radio Dual Connectivity (ENDC) feature is activated and a New Radio Dual Connectivity (NRDC) feature is not supported;
reporting to the network counterpart a detection of a predetermined condition; and
based on a handover command from the network counterpart, switching to a radio access network (RAN) of a (n−1)^{th} generation communication network.

11. The non-transitory machine-readable medium of claim 10, wherein the operations further comprise:
while the predetermined condition is ongoing, disregarding system information block 24 or turning off a SA RAN mode, thereby staying on the RAN of a (n−1)^{th} generation communication network;
determining that the predetermined condition is no longer detected; and
moving back to the SA RAN operating with the n^{th} generation communication network.

12. The non-transitory machine-readable medium of claim 10, wherein:
the connecting to the SA RAN further comprise connecting to the SA RAN operating with a 5G communication network; and
the switching to the RAN further comprises switching to the RAN of a 4G LTE communication network.

13. The non-transitory machine-readable medium of claim 12, wherein the operations further comprise sending, to the network counterpart, UE assistance information including a preference for the SA RAN operating with the 5G communication network or the RAN of the 4G LTE communication network.

14. The non-transitory machine-readable medium of claim 13, wherein the operations further comprise determining the preference for the SA RAN operating with the 5G communication network or the RAN of the 4G LTE communication network based on a battery life, a network traffic speed, an end user preference configured in the UE, application performance requirements, or a combination thereof.

15. The non-transitory machine-readable medium of claim 10, wherein the reporting to the network counterpart the detection of the predetermined condition further comprises reporting to the network counterpart the detection of mmWave coverage; and
the operations further comprise connecting to an anchor node of the (n−1)^{th} generation communication network as a main cell group and connecting to a mmWave node of the n^{th} generation communication network as a secondary cell group.

16. A method, comprising:
inquiring, by a processing system including a processor, capability of a first user equipment (UE) connected to a standalone radio access network (SA RAN) operating with a n^{th} generation communication network;
determining, by the processing system, the inquired capability of the first UE that the first UE supports an E-UTRAN New Radio Dual Connectivity (ENDC) function and does not support New Radio Dual Connectivity (NRDC) function;
receiving, by the processing system, from the first UE, a first message that a predetermined condition has been detected; and
handing over, by the processing system, the connection to the first UE to a radio access network (RAN) of a (n−1)^{th} generation communication network.

17. The method of claim 16, further comprising:
inquiring, by the processing system, capability of a second user equipment (UE) connected to the SA RAN operating with the n^{th} generation communication network;
determining, by the processing system, the capability of the second UE that the second UE supports both the ENDC function and the NRDC function;
receiving, by the processing system, from the second UE, a second message that the predetermined condition has been detected; and
maintaining, by the processing system, a connection to the SA RAN with the n^{th} generation communication network.

18. The method of claim 16, wherein the receiving, from the first UE, the first message that the predetermined condition has been detected further comprises receiving, from the first UE, the first message that the first UE has detected mmWave coverage; and
the handing over the connection to the first UE further comprises handing over the connection to the first UE to an anchor node of the RAN of the (n−1)^{th} generation communication network and adding a connection of the first UE to a mmWave node of the SA RAN of the n^{th} generation communication network as a secondary node using the ENDC function.

19. The method of claim 18, further comprising:
connecting, by the processing system, the first UE to the SA RAN with a 5G communication network; and
moving, by the processing system, the connection of the first UE to the RAN of a 4G LTE communication network such that the first UE is connected to an eNodeB as a main cell group and a mmWave gNodeB as a secondary cell group using the ENDC function.

20. The method of claim 16, further comprising:
receiving, by the processing system, UE assistance information (UAI) from the first UE;
analyzing, by the processing system, the received UAI to determine a preference of the first UE to stay on the SA RAN of the n^{th} generation communication network or move to the RAN of the (n−1)th generation communication network; and
determining, by the processing system, whether to move the connection to the first UE to the RAN of the (n−1)^{th} generation communication network based on the preference of the first UE, or alternatively regardless the preference of the first UE.
